(19) United States
(12) Patent Application Publication
(10) Pub. No.: US 2026/0225147 A1
(43) Pub. Date: Aug. 6, 2026

(54) PRODUCTION PLANT COMPRISING A MANIPULATOR

(71) Applicant: TRUMPF Maschinen Austria GmbH & Co. KG., Pasching (AT)

(72) Inventors: Thomas DENKMEIER, Traun (AT); Nenad KOVJENIC, Linz (AT); Florian MAIER, Leonding (AT)

(73) Assignee: TRUMPF Maschinen Austria GmbH & Co. KG., Pasching (AT)

(21) Appl. No.: 19/151,708

(22) PCT Filed: Jan. 31, 2024
(86) PCT No.: PCT/AT2024/060027

§ 371 Date: Jul. 29, 2025

(30) Foreign Application Priority Data
Jan. 31, 2023 (AT) A50052/2023

(51) Int. Cl. B21D 43/10; B21D 5/00; B21D 5/02; B21D 43/20; B25J 9/00

(52) U.S. Cl. CPC B21D 43/105; B21D 5/002; B21D 5/0281; B21D 43/20; B25J 9/0096

(57) ABSTRACT

A production system for processing plate-like components includes at least one forming machine with at least one adjustable receiving device defining a receiving plane for intermediate component storage. At least one manipulator for component handling is configured to deposit and receive the components according to the intermediate storage at the receiving device. The receiving device includes separate receiving elements adjustable in the receiving plane. Each receiving element includes a bearing unit by which it is rotatable about a bearing axle perpendicular to the receiving plane and is adjustable longitudinally in an actuation direction parallel to the receiving plane and perpendicular to the bearing axle at a spacing to the bearing axle. The manipulator includes a coupling unit for establishing a coupling state with the respective receiving elements where the receiving elements are rotatable relative to the bearing axle and/or adjustable relative to the actuation direction by the manipulator.

The invention relates to a production system for processing plate-like components comprising at least one forming machine with at least one adjustable receiving device that defines a receiving plane for an intermediate storage of the components. It further comprises at least one handling system for handling the components that is configured to deposit and receive the components according to the intermediate storage at the receiving device.

The receiving device comprises separate receiving elements that can be adjusted in the receiving plane, wherein each receiving element has a bearing unit by means of which bearing unit it can be rotated about a bearing axle arranged perpendicular to the receiving plane and can be adjusted longitudinally in an actuation direction parallel to the receiving plane and perpendicular to the bearing axle at a spacing to the bearing axle.

Such receiving and depositing devices in production systems for components are known in the art. For example, they are used as regripping stations for handling systems so that the handling system can deposit the component and pick it up again, such as to better supply the component to the forming machine or to be able to pick it up from a different side. These receiving devices can preferably be linearly movable, such that they can be positioned in a working area of the machine or be moved out of said area again.

U.S. Pat. No. 7,210,328 B2 discloses a metal sheet folding device having a table beam stationarily arranged on a machine frame and a press beam arranged adjustably in relation to the table beam.

Furthermore, the device has a depositing device for at least one workpiece for an intermediate positioning for carrying out a gripping operation on the workpiece with a gripping device of a handling system, wherein the depositing device is supported on the machine frame, preferably on the table beam, such that it can be adjusted in a linear guide arrangement in the direction of a longitudinal extension of the table beam over at least part of the length.

The receiving devices known in the art have the disadvantage that their receiving elements are not always configured to the workpiece or component geometry and have to be adjusted by an operator. This requires manual configuration of the axles of the receiving elements, whereby the operator has to enter the space between the handling system and the forming machine, which poses an increased safety risk.

The object of the present invention was to overcome the disadvantages of the prior art and to provide a production system that enables an operator to configure the receiving device and the receiving elements in a simpler manner without an operator being exposed to a substantial hazard zone of the production system.

This object is solved by a device and a method according to the claims.

The production system according to the invention is characterized in that the handling system comprises a coupling unit, wherein a coupling state with the respective receiving elements can be established by the coupling unit and in the coupling state the receiving elements can be rotated in relation to the bearing axle and/or adjusted in relation to the actuation direction by the handling system.

The embodiment according to the invention can improve operating safety for people in a production system in that it is no longer necessary for operating personnel to be present in the system area to configure the receiving device.

Furthermore, the embodiment according to the invention can reduce the waiting and idle time of the production system because no additional machine processes or shutdowns are required.

The receiving device can preferably be configured in such a way that the receiving elements only have passive coupling elements for connection with the coupling unit, such that all adjustment and rotation drives and sensors that operate, adjust or detect the corresponding coupling elements on the receiving device are arranged on the coupling unit (or on the handling system). The receiving device can thus have a simple mechanical construction and nevertheless be adjusted in a highly-automated way.

According to a possible embodiment it can be provided that the coupling unit has an engaging element for rotating the receiving element in relation to the bearing axle, wherein at least one engaging section is provided on the receiving element for coupling with the engaging element. It is thus possible to perform the rotation of the receiving elements by means of a simple movement of the handling system or of the coupling unit in the coupling state via mechanical engagement, positive locking or similar.

A possible further embodiment provides that the engaging element and the engaging section are further configured to be adjusted in relation to the actuation direction. The advantage of this embodiment is that the rotation and adjustment of the receiving elements can be performed simultaneously by means of a single element of the coupling unit.

Furthermore, it can be provided that the receiving element comprises an actuation mechanism for adjusting the spacing of the receiving element to the bearing unit in relation to the actuation direction and that the coupling unit comprises a drive mechanism, wherein the actuation mechanism can be adjusted by the drive mechanism. The advantage of this embodiment is on the one hand that a precise configuration of the receiving elements is possible via the actuation mechanism, and on the other hand that no translational movement of the handling system is required for this adjustment, meaning that surrounding components etc. need not be taken into consideration.

In this respect, a further embodiment provides that the actuation mechanism has a gearing, wherein a drive element that can be brought into operative engagement with the gearing can be driven by the drive mechanism. The drive element can be, for example, a drivable pinion supported on the receiving element. Furthermore, it can also be arranged on the coupling element.

A preferred embodiment provides that a positioning means for determining a current rotary position of the receiving element in relation to the bearing axle is provided on the receiving element, wherein the positioning means can be detected by the coupling unit. A positioning means enables an automatic alignment of the coupling unit in relation to the rotary position of the receiving element for establishing the coupling state. Moreover, it is thereby easier to determine the spacing of the receiving element in relation to the bearing axle.

A further embodiment provides that the positioning means is a permanent magnet. By using a permanent magnet it is possible to clearly detect a position due to its magnetic field, e.g. using a Hall effect sensor.

According to a possible embodiment, it can be provided that a reference means for determining a longitudinal position of the receiving element in relation to the actuation direction is provided on the receiving element, wherein the reference means can be detected by the coupling unit. The reference means can be provided to determine the spacing, or rather the reference means can directly measure the spacing. Furthermore, it can be provided that the reference means is provided to detect a starting position for the configuration of the spacing. The reference means can, for example, thereby form a fixation point for the coupling unit, which is first arrived at for the adjustment of the receiving element and upon arrival at the fixation point the spacing of the receiving element is configured.

A possible further embodiment provides that the coupling unit comprises a proximity sensor, wherein a measurable variable of the proximity sensor is provided by the reference means. Furthermore, the spacing can be configured via the proximity sensor according to this embodiment. The proximity sensor can itself comprise a magnet, but also optical means such as a transmitter and receiver, wherein a passive element, e.g. a reflector, is preferably provided on the receiving element.

A possible embodiment variation provides that the receiving element has a locking unit, wherein the locking unit can be unlocked by the coupling unit in the coupling state and the receiving element is locked by the locking unit when not in the coupling state with respect to at least one of the following movements:
a rotation of the receiving element in relation to the bearing axle;
an adjustment of the receiving element in relation to the actuation direction.

This variation can prevent an unintended adjustment of the receiving element and at the same time enable a smooth adjustment in the coupling state, such that the responsible mechanisms can be provided in a smaller and more economical manner.

A further possible embodiment provides that the receiving element has a friction element in relation to the adjustment in the actuation direction and/or the rotation in relation to the bearing axle, such that a corresponding movement of the receiving element in relation to the rotation and/or adjustment is difficult. Thereby, an unintended further movement in relation to the adjustment process as well as an unintended adjustment of the receiving elements in general can be prevented depending on the adjustment movement by the coupling unit and/or the handling system.

A possible further embodiment provides that the receiving element has at least one return assembly, wherein the receiving element can be returned to a predetermined starting position by means of the return assembly with respect to an adjustment along the actuation direction and/or with respect to the rotation about the bearing axle, wherein the return assembly can be actuated by the coupling unit. The advantage of this embodiment is that no corresponding location or spacing sensor is required since the coupling unit approaches the receiving elements in relation to the bearing axle and can activate the return assembly, thus occasioning the respective movement into the corresponding starting position, whereby the receiving element is automatically adjusted into a reference position for the handling system. The return can occur automatically in the coupling state or be actuated separately by the coupling unit. The return assembly can preferably be coupled with an aforementioned locking unit.

According to a preferred embodiment, it can be provided that the receiving device comprises at least two receiving units, wherein the receiving units can be adjusted towards one another in a direction parallel to the receiving plane and each have the separate receiving elements. The receiving device can, for example, comprise two receiving units configured symmetrically to one another, the spacing of which to one another can be configured in relation to the receiving plane. In addition to the separate receiving elements, an assembly of receiving elements can thereby be adjustable in relation to a receiving unit.

Furthermore, it can be provided that the coupling unit is configured to rotate a plurality of receiving elements simultaneously in relation to their respective bearing axle and/or to adjust them in relation to their actuation direction. A plurality of receiving elements can thereby be put into the coupling state at the same time by one coupling unit, wherein the coupling unit preferably has a plurality of the corresponding mechanisms and sensors, with these being drivable and adjustable separately in relation to a respective receiving element. Preferably, when using separate receiving units the coupling unit can adjust at least all receiving elements of a receiving unit.

A possible embodiment provides that the coupling unit is configured as an exchangeable tool head of the handling system.

For a better understanding of the invention, it is explained in more detail with reference to the following figures.

These show in significantly simplified, schematic representation:

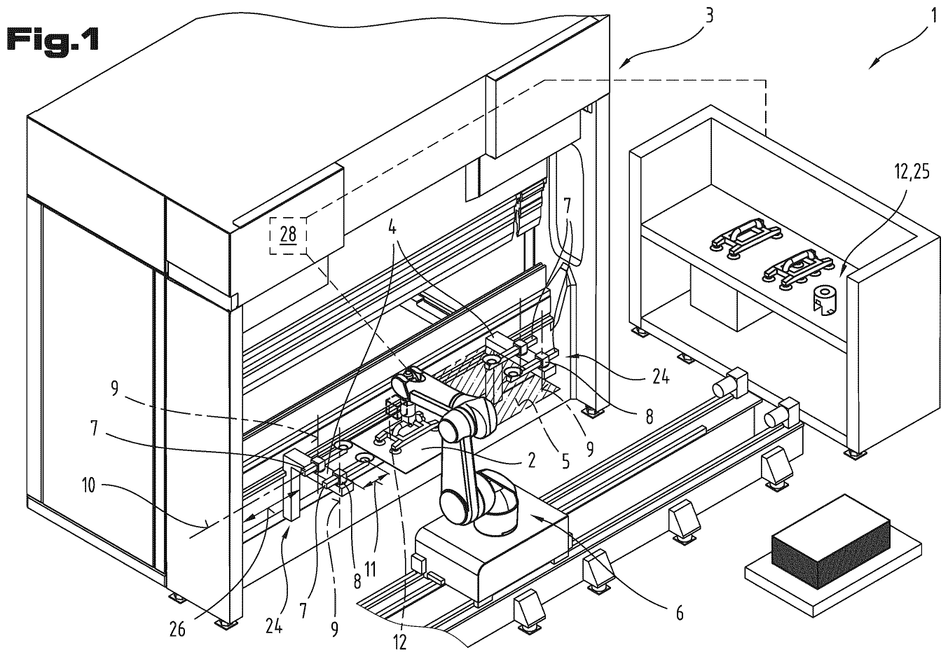

FIG. 1 a production system with a forming machine, a handling system, and a receiving device with separate receiving elements;

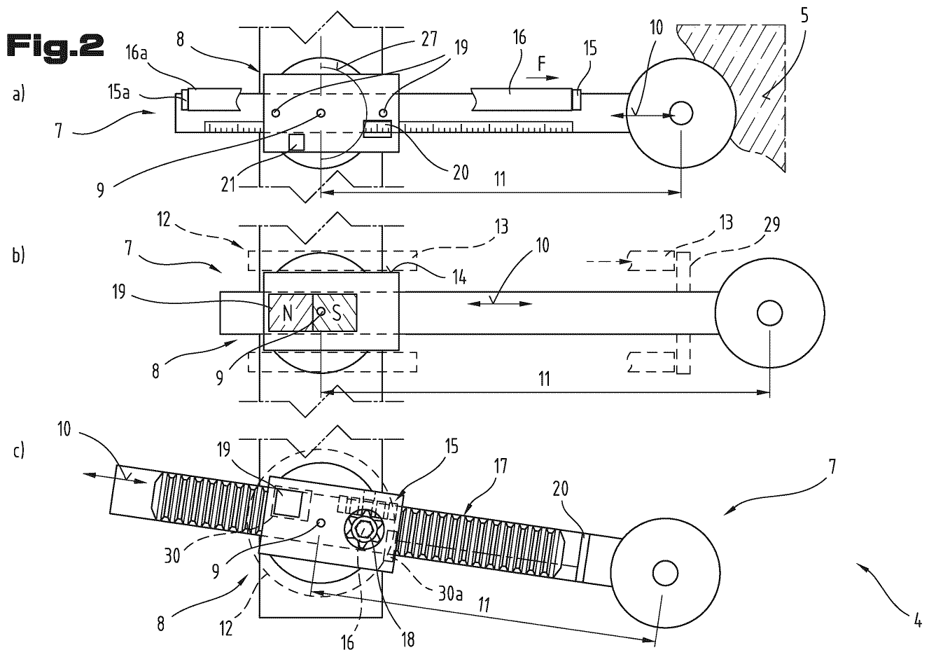

FIG. 2 a) to c) separate, possible embodiments of the receiving elements viewed from above as well as embodiments of the coupling unit;

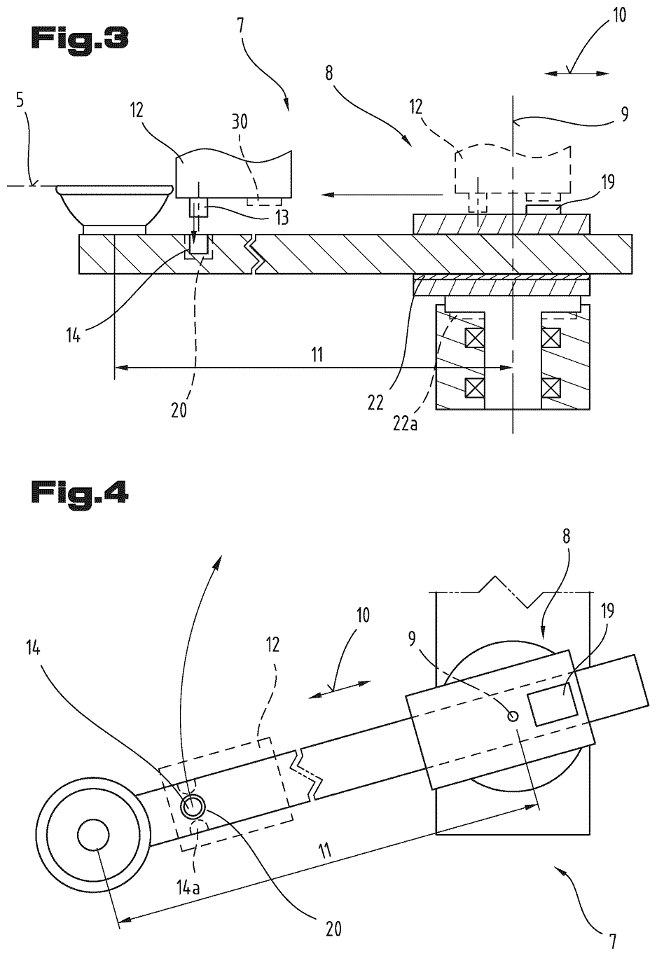

FIG. 3 a possible embodiment of a receiving element and a coupling unit, partly cropped;

FIG. 4 the embodiment according to FIG. 3 viewed from above;

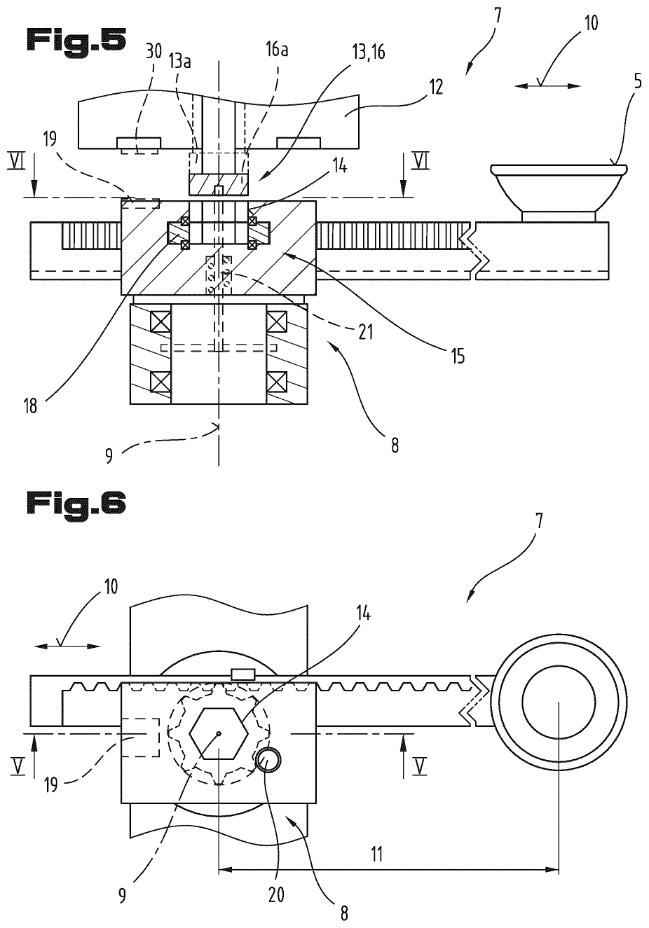

FIG. 5 a further possible embodiment of a drive mechanism with an actuation mechanism, partly cropped;

FIG. 6 the embodiment according to FIG. 5 viewed from above;

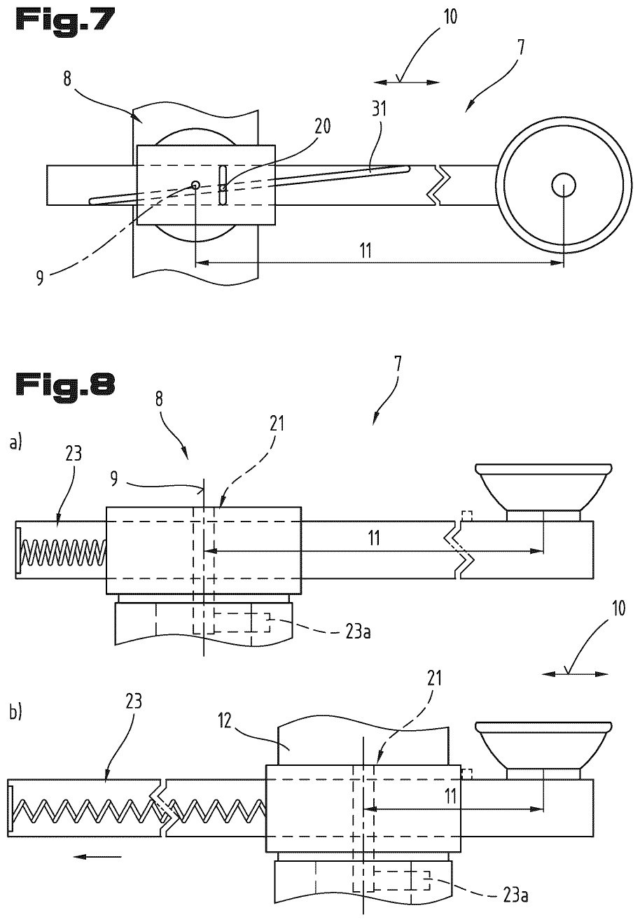

FIG. 7 a possible embodiment of a receiving element with a guide;

FIG. 8 a) and b) a Receiving Element With a Return Assembly.

It is worth noting here that the same parts have been given the same reference numerals or same component configurations in the embodiments described differently, yet the disclosures contained throughout the entire description can be applied analogously to the same parts with the same reference numerals or the same component configurations. The indications of position selected in the description, such as above, below, on the side etc. refer to the figure directly described and shown, and these indications of position can be applied in the same way to the new position should the position change.

FIG. 1 shows a possible production system 1 for processing plate-like components 2.

It comprises at least one forming machine 3 for forming the components 2; as shown, the forming machine 3 can be configured as a folding machine or press brake or similar.

Preferably, at least one adjustable receiving device 4 is provided on the forming machine 3, wherein the receiving device 4 defines a receiving plane 5 for an intermediate storage of the components 2. As indicated, the receiving device 4 can be adjustable in relation to a direction 26 along the forming machine 3. Where the forming machine is a folding machine, the direction 26 is preferably parallel to the folding line.

The at least one handling system 6 for handling the components 2 is configured to deposit and receive the components 2 according to the intermediate storage at the receiving device 4.

The receiving device 4 can further comprise at least two receiving units 24 which can be adjusted to one another in relation to the direction 26 and preferably parallel to the receiving plane 5. In addition, the receiving units 24 can also adapt a width of the receiving device in relation to a component 2 to be received, or the receiving device 4 can also be removed from a working area of the handling system 6.

The receiving device 4 comprises separate receiving elements 7 that can be adjusted in the receiving plane 5, wherein each receiving element 7 has a bearing unit 8 by means of which bearing unit 8 it can be rotated about a bearing axle 9 arranged perpendicular to the receiving plane 5 and can be adjusted longitudinally in an actuation direction 10 parallel to the receiving plane 5 and perpendicular to the bearing axle 9 at a spacing 11 to the bearing axle 9.

It should be noted here that the receiving elements 7 of the respective receiving units 24 are preferably arranged to be facing one another, as shown in FIG. 1, whereby the respective receiving units 24 can be configured symmetrically to one another.

According to the invention, the handling system 6 comprises a coupling unit 12, wherein a coupling state with the respective receiving elements 7 can be established by the coupling unit 12 and in the coupling state the receiving elements 7 can be rotated in relation to the bearing axle 9 (in an angle of rotation) and/or adjusted in relation to the actuation direction 10 by the handling system 6. Depending on the design of the coupling unit 12, it can also be provided that in the coupling state a plurality of receiving elements 7 can be configured simultaneously by the coupling unit 12.

The coupling unit 12 thereby preferably has the drive means, rotary encoders and sensors needed for adjustment that can be operated with the handling system, or can at least be powered via the handling system.

As further indicated, the coupling unit 12 can also be configured as an exchangeable tool head 25 of the handling system 6, which can, for example, be received in a tool magazine.

Alternatively, the coupling unit 12 can also be a separate assembly arranged on the handling system which remains on the handling system even when a gripping head or similar is used and which can, for example, be pivoted into place for configuration of the receiving device. The coupling unit can further also have its own computing unit etc. and have a data connection with the handling system or its control unit via interfaces.

The production system 1 preferably further has a control device 28 that is communicatively connected to the handling system 6, the forming machine 3 and an adjusting drive of the receiving device (in relation to the direction 26).

The receiving elements 7 are shown in the figures as suction arms with separate suction cups, although the invention is not limited to this embodiment and the receiving elements can also have other parts for receiving a component 2 and can also have a plurality of suction cups per arm, etc. The number of receiving elements of the receiving device can be variable and differ by receiving unit, wherein preferably 4 receiving elements can be provided per receiving unit.

Irrespective of the embodiment of the receiving elements 7, the coupling unit 12 (or the handling system) is configured in such a way that the position of the receiving element 7 vis-à-vis the receiving device 4 or the forming machine can be determined by the position of the bearing axle 9, which is preferably stationary in relation to the receiving device 4. The rotary position of the arm of the receiving element 7 can thereby be detected in relation to the bearing axle 9, whereby the handling system recognizes an orientation of the actuation direction.

The handling system fundamentally knows the position of the receiving device 4 or the receiving units 24 in relation to the direction 26 in FIG. 1 from the control device, from which direction 26 the respective bearing axles 9 are also known. The same applies for a possible height adjustment of the entire receiving device, e.g. perpendicular to the receiving plane, and an adjustment of the receiving device in a direction towards the forming machine.

For the sake of completeness, it should be noted here that with respect to the control of the handling system, the component geometry of a component to be folded or processed is known and the parameters to be configured of the separate receiving elements of the receiving device can be derived from those data, and thus the corresponding commands can be issued to the handling system (together with the coupling unit) depending on the respective component geometries. In other words, the control device of the handling system can preferably be equipped to configure the receiving elements in relation to the bearing axle and the actuation direction depending on the component geometry of a workpiece to be processed.

Different embodiments and mechanisms that are provided on the coupling unit 12 and the receiving device 4, wherein passive coupling elements are preferably provided on the receiving unit 4 or the receiving elements 7 that can be activated, deactivated or operated by the coupling unit 12, can be provided for the adjustment of the receiving elements 7 in relation to the actuation direction 10 and/or the bearing axle 9.

In this regard, FIG. 2 shows various possible embodiments of the receiving elements in relation to their adjustment in the actuation direction 10 and in relation to the rotation about the bearing axle 9.

It should be noted here that in relation to the adjustment in the actuation direction the separate variations of the receiving elements 7 shown in FIG. 2a) to c) can be configured independently of the variation of the rotation about the bearing axle shown in the same figure, and can be configured in different combinations of the separate variations shown in relation to rotation and adjustment.

In relation to an entire receiving device, all receiving elements for coupling with the coupling unit can, however, have the same configuration, whereby all receiving elements thus have the same selected combination of the possible embodiments shown.

In this regard, for the detection of the spacing 11, a reference means 20 for a longitudinal position of the receiving element 7 in relation to the actuation direction 10 can be provided on the receiving element 7, wherein the reference means 20 can be detected by the coupling unit 12 or a detection unit 30.

Preferably, a positioning means 19 for a current rotary position of the receiving element 7 in relation to the bearing axle 9 can be provided on the receiving element 7, wherein the positioning means 19 can be detected by the coupling unit 12. In this regard, a suitable detection unit 30 can be provided on the coupling unit 12.

According to a possible embodiment, it can be provided that the receiving element 7 comprises an actuation mechanism 15 to adjust the spacing 11 of the receiving element 7 to the bearing unit 8 in relation to the actuation direction 10 and that the coupling unit 12 comprises a drive mechanism 16, wherein the actuation mechanism 15 can be adjusted by the drive mechanism 16.

In FIG. 2, a) the drive mechanism 16, 16a is provided in the form of a linear actuator that adjusts the receiving element 7 in relation to the actuation direction 10 by means of the respective actuation mechanisms 15, 15a in the form of end stops, as indicated by the force arrow F. The coupling unit itself, which comprises the drive mechanism, is not shown. The linear actuator can thereby have separate telescope elements or similar that can be moved in the direction of the actuation mechanisms 15, 15a according to the spacing 11 to be configured. In this embodiment, a reference means 20 can fundamentally be omitted as the spacing can be automatically configured on the basis of the adjustment movement to the respective actuation mechanisms 15, 15a, since upon arriving at the respective end position the receiving element 7 is pushed into the desired position between the two end stops.

It can further be provided that the positioning means 19 is formed by a 2-point reference system, as also shown in FIG. 2, a). In relation to this embodiment, it can be provided that the receiving elements 7 can, for example, be rotatable in relation to an area of less than 180° with respect to the bearing axle 9, such that a unique orientation (or angle of rotation) of the receiving element 7 can be clearly determined using the 2 points. In this regard, a movement zone 27 is indicated into which the receiving elements 7 can be rotated in the receiving plane 5, wherein this movement zone 27 can fundamentally be provided for all possible embodiments of the receiving elements. The mentioned 2-point sensory technology can be determined in different ways, e.g. optically or using a suitable proximity sensor.

Furthermore, the reference means 20 can be configured as a scale that can be detected via a window by means of the coupling unit 12 or the detection unit, as also shown in FIG. 2, a). The scale can also be optically detectable.

Furthermore, irrespective of the embodiment, the receiving element 7 can have a locking unit 21, wherein the receiving element 7 is locked by the locking unit 21 in relation to the rotation about the bearing axle 9 and/or the adjustment in relation to the actuation direction 10, and in the coupling state the locking unit 21 can be unlocked by means of the coupling unit 12, such that the receiving element 7 is unlocked and movable in relation to the rotation about the bearing axle 9 and/or the adjustment in relation to the actuation direction 10.

The reference means 20 can also be provided in the form of a magnet or comprise other evaluable or readable means that can be detected by the coupling unit 12. According to one embodiment, it can be provided that the coupling unit 12 detects or calculates the spacing 11 of the receiving element 7 in the actuation direction 10, for example using optical means such as a transmitter/receiver or reflector. Reference is hereby made to the prior art regarding proximity sensors, wherein a passive proximity sensor part can preferably be arranged on the receiving element.

The actuation mechanism 15 can also have gearing 17, wherein a drive element 18 that can be brought into operative engagement with the gearing 17 can be driven by the drive mechanism 16. The drive element 18 can be arranged on the receiving element 7 or on the coupling unit 12. As shown in FIG. 2, c), the actuation mechanism 15 can have further parts, as is indicated by the gear represented by a dashed line.

Furthermore, FIG. 2, c) shows, irrespective of the embodiment in relation to the adjustment mechanisms, a detection unit 30 of the coupling unit 12, wherein the reference means 20 is provided in the form of a reflector on the receiving element 7 in relation to the actuation direction and the coupling unit has a transmitter/receiver assembly for determining the spacing 11, as is indicated with the detection unit 30a represented by a dashed line.

For the sake of completeness, it should be noted here that the detection unit 30 can have separately arranged and adjustable elements on the coupling unit 12 irrespective of the shown embodiment in relation to the reference means 20 and the positioning means 19.

As shown, the positioning means 19 can comprise a permanent magnet as mentioned at the beginning, the alignment of which can be detected by a sensor of the coupling unit 12, e.g. a Hall effect sensor, as also mentioned at the beginning.

A further possible embodiment provides that the coupling unit 12 has an engaging element 13 for rotating the receiving element 7 in relation to the bearing axle 9, wherein at least one engaging section 14 is provided on the receiving element 7 for coupling with the engaging element 13. The engaging section 14 can, for example, be formed by a simple geometric shape, e.g. by the bearing unit 8 of the receiving element 7, wherein the coupling unit 12 can have a complementary engaging element 13, as indicated in FIG. 2, b). Moreover, a further possible embodiment for adjustment in relation to the actuation direction 10 is indicated by the coupling unit 12 moving with the engaging element 13 before or after the rotation process about the bearing axle 9 in the actuation direction 10 into a desired position to carry the receiving element 7 with it in the actuation direction 10 (or to push it back in the counter-direction) by means of stop elements 29. Furthermore, a touch element not shown here can be arranged on the engaging element 13, the former detecting a contact with the stop element 29 whereby the spacing 11 can also be calculable. Aforementioned friction elements can be provided in relation to such a displacement.

A further embodiment of the coupling unit 12 with an engaging element 13 that is configured to rotate the receiving element 7 in relation to the bearing axle 9 by means of the engaging section 14 and is further configured for adjustment in relation to the actuation direction 10 is shown in FIGS. 3 and 4. As shown, the coupling unit 12 can first orient itself towards the bearing axle 9 (preferably again with a positioning means 19 and a detection unit 30) and then moves in the actuation direction 10 towards the reference means 20 arranged on the arm of the receiving element 7, the reference means also being provided by the engaging section 14 or being arranged in its area. Following successful detection, the engaging element 13 is adjusted into the engaging section 14, by means of which the receiving element can be adjusted in the actuation direction 10 and rotated in relation to the bearing axle 9.

The engaging section 14 can be configured in different ways and also be arranged at the edge of the receiving element 7, such that the engaging element engages from the respective side in relation to the rotation direction about the bearing axle 9, as indicated with engaging section 14a. Alternatively, a gripper device can be provided as engaging element, wherein the engaging section only has one reference position or the like, for instance.

Furthermore and irrespective of the embodiment of the receiving elements 7, it can be provided that the receiving element 7 has a friction element 22 in relation to the adjustment in the actuation direction 10 and/or the rotation in relation to the bearing axle 9, such that a corresponding movement of the receiving element 7 is difficult. The friction elements 22, 22a are indicated in this regard.

It ought to be noted that referring to an adjustment of the coupling unit 12 perpendicular to the receiving plane 5, the handling system fundamentally knows the height position in relation to this perpendicular direction due to the position of the receiving device, wherein additional sensors can be provided in relation to the height adjustment.

A further possible embodiment of a coupling unit 12 with a drive mechanism 16 for adjusting an actuation mechanism 15 is shown in FIGS. 5 and 6, wherein the drive mechanism 16 simultaneously comprises the engaging element 13 and is provided in the area of the engaging section 14 of the actuation mechanism 15.

The embodiment of the engaging element 13 shown in FIGS. 5 and 6 is suitable for rotating the receiving element 7 about the bearing axle 9 by means of the engaging section 14 as well as for the coupling and activation of the actuation mechanism 15. Alternatively, a separately rotatable engaging element 13a as well as a separately rotatable drive element of the drive mechanism 16a that are provided to simultaneously occasion the rotation about the bearing axle 9 and the adjustment in the actuation direction 10 can be provided on the coupling unit, as indicated by the dashed line.

In turn, a detectable reference means 20 can be provided on the receiving element 7 for determining the spacing 11 in relation to the actuation direction 10. Furthermore, the reference means 20 can be integrated in the actuation mechanism 15 such that it is also adjustable with the rotation movement of the actuation mechanism 15, for instance. For example, the drive mechanism 16 can adjust a reference means 20 via the actuation mechanism 15 in a direction parallel to the bearing axle 9, wherein the current position of the reference means 20 in relation to this direction can be detected by the coupling unit, whereby the spacing 11 can be determined.

Furthermore, an aforementioned locking unit 21 can be provided, wherein the locking unit 21 can be unlocked by inserting the drive mechanism 16 or by the engaging element 13, for example, as indicated with the locking unit 21 in FIG. 5 by a dashed line, as well as the recess provided for that purpose on the engaging element.

Depending on the embodiment, the detection unit 30 can preferably be rotatable together with the engaging element 13, such that it is moved together in the direction of rotation to the bearing axle 9 for the detection of the reference means 20 in relation to the orientation of the actuation direction 10. For example, at least parts of the coupling unit 12 can rotate together with the engaging element 13 or have a rotary disk or similar coupled with the rotation of the engaging element 13 for the detection unit.

It can further be provided that the reference means 20 is provided by a tappet that can be adjusted by adjusting the receiving element 7 in the actuation direction 10 using a guide 31 transverse to the actuation direction 10, as indicated in FIG. 7, wherein the displacement of the tappet transverse to the actuation direction can be detected by the coupling unit and thus the spacing 11 be determined.

Furthermore and independently of the respective mechanisms for adjusting the receiving element, the receiving element 7 can have at least one return assembly 23, wherein the receiving element 7 can be returned to a pre-determined starting position by the return assembly 23 following an adjustment in the actuation direction 10 and/or a rotation about the bearing axle 9, wherein the return assembly 23 can be actuated by the coupling unit 12.

The return assembly 23 can, for example, be implemented using a compressed air system, such that for the return a compressed air channel that can be supplied with compressed air by the handling system or via the coupling unit is provided on the receiving element, whereby the return can be occasioned.

This embodiment enables the same starting position for the handling system to be established by the return assembly 23 for the configuration of the spacing 11 in relation to the actuation direction 10, as shown in FIG. 8 with positions a) and b). For instance, the return assembly 23 in FIG. 8 comprises an elastic spring element, but it can also comprise other means which can occasion a linear return.

For example, a return assembly that can return the actuation mechanism, e.g. individual gears, into a starting position can also be integrated in an actuation mechanism as previously described.

In addition, a return assembly that returns the receiving element 7 into a starting position or starting angle in relation to the bearing axle 9 can also be provided in relation to the rotation about the bearing axle 9, as indicated with the return assembly 23a. The return in relation to the bearing axle 9 can preferably correspond to a right-angled position of the receiving elements 7 to their support assembly on the receiving device (according to the alignment in FIG. 1).

An own lock can be provided to obstruct or lock the return assemblies in operation, which in turn can be activated or deactivated with the coupling unit. The return assemblies 23, 23a can preferably also be activated by the locking unit 21, or also be coupled to the locking unit of the receiving element 7. The return can further also be obstructed by an aforementioned friction element, the contact pressure or position of which can, for example, be adjusted by the coupling unit.

Depending on the embodiment of the return assembly, further elements such as limiting elements can be provided that limit the return movement, for instance form a limit stop in relation to the actuation direction.

It can further be provided that all return assemblies of the separate receiving elements of the receiving device are coupled with one another in such a way that they can be returned together upon activation by the coupling unit or by the handling system.

FIGS. 3 to 8 show further and possibly independent embodiments of the receiving elements and the coupling unit, again using the same reference numerals or component designations for the same parts as in the preceding FIG. 1 to 2. To avoid unnecessary repetition, reference is made to the detailed description in the preceding figures.

The example embodiments show possible embodiment variations, although it is to be noted here that the invention is not limited to the specifically represented embodiment variations of the same, but rather various combinations of the individual embodiment variations with one another are possible, and that given the technical teachings provided by the present invention this variation possibility is within the ability of the skilled person in this technical field.

All value ranges specified in the current description are to be understood such that they include any and all sub-ranges, e.g., the specification 1 to 10 is to be understood such that all sub-ranges, starting from the lower limit 1 and the upper limit 10 are included, i.e., all sub-ranges begin with a lower limit of 1 or more and end at an upper limit of 10 or less, e.g., 1 to 1.7, or 3.2 to 8.1, or 5.5 to 10.

As a matter of form and by way of conclusion, it is noted that, to improve understanding of the structure, elements have partially not been shown to scale and/or enlarged and/or shrunk.

List of reference numerals

| | |
|---|---|
| 1 | Production system |
| 2 | Component |
| 3 | Forming machine |
| 4 | Receiving device |
| 5 | Receiving plane |
| 6 | Handling system |
| 7 | Receiving element |
| 8 | Bearing unit |
| 9 | Bearing axle |
| 10 | Actuation direction |
| 11 | Spacing |
| 12 | Coupling unit |
| 13 | Engaging element |
| 14 | Engaging section |
| 15 | Actuation mechanism |
| 16 | Drive mechanism |
| 17 | Gearing |
| 18 | Drive element |
| 19 | Positioning means |
| 20 | Reference means |
| 21 | Locking unit |
| 22 | Friction element |
| 23 | Return assembly |
| 24 | Receiving units |
| 25 | Exchangeable tool head |
| 26 | Direction |
| 27 | Movement zone |
| 28 | Control device |
| 29 | Stop element |
| 30 | Detection unit |
| 31 | Guide |

1: A production system (1) for processing plate-like components (2) comprising
at least one forming machine (3) for forming the components (2) with at least one adjustable receiving device (4), wherein the receiving device (4) defines a receiving plane (5) for the intermediate storage of the components (2);
at least one handling system (6) for handling the components (2), wherein the handling system (6) is configured to deposit and receive the components (2) according to the intermediate storage at the receiving device (4),
wherein the receiving device (4) comprises separate receiving elements (7) that are adjustable in the receiving plane (5) and each receiving element (7) comprises a bearing unit (8), by means of which bearing unit (8) it is rotatable about a bearing axle (9) arranged perpendicular to the receiving plane (5) and is adjustable longitudinally in an actuation direction (10) parallel to the receiving plane (5) and perpendicular to the bearing axle (9) at a spacing (11) to the bearing axle (9), wherein
the handling system (6) comprises a coupling unit (12), wherein the coupling unit (12) is configured to establish a coupling state with the respective receiving elements (7) and in the coupling state the receiving elements (7) are rotatable with respect to the bearing axle (9) and/or adjustable with respect to the actuation direction (10) by the handling system (6).

2: The production system (1) according to claim 1, wherein the coupling unit (12) comprises an engaging element (13) for rotating the receiving element (7) in relation to the bearing axle (9), wherein at least one engaging section (14) is provided on the receiving element (7) for coupling with the engaging element (13).

3: The production system (1) according to claim 2, wherein the engaging element (13) is further configured to adjust the receiving element in relation to the actuation direction (10).

4: The production system (1) according to claim 1, wherein the receiving element (7) comprises an actuation mechanism (15) to adjust the spacing (11) of the receiving element (7) to the bearing unit (8) in relation to the actuation direction (10) and wherein the coupling unit (12) comprises a drive mechanism (16), wherein the actuation mechanism (15) is adjustable by means of the drive mechanism (16).

5: The production system (1) according to claim 4, wherein the actuation mechanism (15) comprises a gearing (17), wherein a drive element (18) that can be brought into operative engagement with the gearing (17) is drivable by means of the drive mechanism (16).

6: The production system (1) according to claim 1, wherein a positioning means (19) for determining a current rotary position of the receiving element (7) in relation to the bearing axle (9) is provided on the receiving element (7), wherein the positioning means (19) is detectable by means of the coupling unit (12).

7: The production system (1) according to claim 6, wherein the positioning means (19) is a permanent magnet.

8: The production system (1) according to claim 1, wherein a reference means (20) for determining a longitudinal position of the receiving element (7) in relation to the actuation direction (10) is provided on the receiving element (7), wherein the reference means (20) is detectable by means of the coupling unit (12).

9: The production system (1) according to claim 8, wherein the coupling unit (12) comprises a proximity sensor, wherein a measurable variable of the proximity sensor is provided by the reference means (20).

10: The production system according to claim 1, wherein the receiving element (7) comprises a locking unit (21), wherein the locking unit (21) is unlockable by means of the coupling unit (12) in the coupling state and the receiving element (7) is lockable by means of the locking unit (21) when not in the coupling state with respect to at least one of the following movements:
a rotation of the receiving element (7) in relation to the bearing axle (9);
an adjustment of the receiving element (7) in relation to the actuation direction (10).

11: The production system according to one of claim 1, wherein the receiving element (7) comprises a friction element (22) with respect to the adjustment in the actuation direction (10) and/or the rotation with respect to the bearing axle (9), such that a corresponding movement of the receiving element (7) is sluggish.

12: The production system according to claim 1, wherein the receiving element (7) comprises at least one return assembly (23), wherein the receiving element (7) is returned to a pre-determined starting position by means of the return assembly (23) with respect to an adjustment along the actuation direction (10) and or a rotation with respect to the bearing axle (9), wherein the return assembly (23) is actuated by means of the coupling unit (12).

13: The production system (1) according to claim 1, wherein the receiving device (4) comprises at least two receiving units (24), wherein the receiving units (24) are adjustable towards one another in a direction parallel to the receiving plane (5) and each have the separate receiving elements (7).

14: The production system (1) according to claim 1, wherein the coupling unit (12) is configured to simultaneously rotate a plurality of receiving elements (7) with respect to the respective bearing axle (9) and/or adjust them with respect to the respective actuation direction (10).

15: The production system (1) according to claim 1, wherein the coupling unit (12) is configured as an exchangeable tool head (25) of the handling system (6).
